(19) United States
(12) Patent Application Publication
(10) Pub. No.: US 2002/0190642 A1
(43) Pub. Date: Dec. 19, 2002

(54) Radiation flux monitor for EUV lithography

(76) Inventors: Kurt W. Berger, Livermore, CA (US); Avijit K. Ray-Chaudhuri, Livermore, CA (US)

Correspondence Address: KURT C. OLSEN, SANDIA NATIONAL LABORATORIES, P O BOX 969 MS 9031, LIVERMORE, CA, 94551-0969, US

(21) Appl. No.: 09/885,813

(22) Filed: Jun. 19, 2001

(51) Int. Cl. H01J 40/06

(52) U.S. Cl. 313/542

(57) ABSTRACT

A device for monitoring radiation flux from a surface. The flux monitor is based on the photoelectric effect that occurs inherently when a reflective metal optic is exposed to a beam of energetic radiation. The incoming beam of energetic radiation is not totally reflected by the optic surface. That portion of the radiation absorbed by the optic generates photoelectrons producing a signal proportional to the incident radiation flux. By measuring this signal, an accurate determination of the radiation reflected by the optic surface can be made.

### STATEMENT OF GOVERNMENT INTEREST

This invention was made with Government support under contract no. DE-AC04-94AL85000 awarded by the U.S. Department of Energy to Sandia Corporation. The Government has certain rights in the invention.

### CROSS-REFERENCE TO RELATED APPLICATIONS

Not applicable.

### BACKGROUND OF THE INVENTION

This invention is directed to a device for measuring the flux of electromagnetic radiation from reflective optics and particularly the flux of radiation from reflective optics used in extreme ultraviolet (EUV) and x-ray lithography.

Integrated circuits are presently manufactured using projection lithography. The basic components of an optical projection lithography system include a radiation source, a condenser system to collect the source radiation and direct it onto a mask, a mask containing the pattern to be printed on the wafer, and a reduction imaging lens system that projects an image of the mask pattern onto a wafer coated with a photosensitive resist material. The patterned photoresist is developed after exposure and the mask pattern etched onto the substrate.

In any lithographic system there can be variations in radiation flux, the quantity of radiation striking unit area in unit time, over the length of a single wafer exposure (dose) as well as from wafer to wafer. In order to ensure proper exposure of the photoresist material it is desirable to maintain control of radiation flux to within +/−1%.

In order to faithfully reproduce a mask pattern the necessity to maintain tight control over radiation flux or dose is particularly true for EUV lithography w here the radiation source can be pulsed laser heating of a target material, such as a frozen xenon pellet or a high density gas jet, as described in U.S. Pat. No. 5,577,092. While the use of laser heating of a target material provides certain advantages, the process can suffer from shot-to-shot variation in flux as well as long-term drift. Thus, a real-time and non-invasive radiation flux monitor is needed to ensure proper exposure of photoresist materials.

### SUMMARY OF THE INVENTION

The present invention is directed to a real-time, non-invasive radiation flux monitor. The flux monitor is based on the photoelectric effect that occurs inherently w hen a beam of energetic radiation strikes a reflective optic. An incoming beam of energetic radiation is not totally reflected by the optic surface; a portion of the radiation is absorbed by the optic. Radiation whose energies span the EUV and x-ray wavelengths has sufficient energy to overcome the electron work function and binding energy of the material comprising the reflective optic to generate photoelectrons. If the mirror reflectivity does not change over time then the photoelectron signal will be proportional to the incident radiation flux. By measuring this signal, an accurate determination of the radiation incident to the optic surface can be made and the radiation flux and dose delivered to the photoresist material can be monitored.

### BRIEF DESCRIPTION OF THE DRAWINGS

The accompanying drawing, which is incorporated in and forms part of the specification, illustrates the present invention and, together with the description, explains the invention. In the drawing like elements are referred to by like numbers, wherein:

FIG. 1 is a schematic view of the radiation flux monitor according to the invention.

### DETAILED DESCRIPTION OF THE INVENTION

The present invention provides a device for measuring the current produced by photoelectrons ejected from a metal surface by energetic incident radiation. Thus, the device can be used to determine radiative flux from a reflective surface and its variation with time.

As integrated circuits have become smaller demands to achieve submicron resolution with sufficient line width control on a substrate have become increasingly important. As the feature size decreases, the wavelength of light required for submicron resolution decreases (for a design rule of 0.1 μm light with a wavelength of about 13 to 15 μm is preferred) with a corresponding increase in the photon energy. At these shorter wavelengths the light is so strongly attenuated that all materials become opaque. Thus, extreme ultraviolet lithography (EUVL), which is an extension of optical lithography to the wavelength region of 3-15 nm, requires the use of reflective optics, and particularly optics having special coatings that achieve high reflectivities at the operating wavelength.

Currently, the reflective optics and masks used for extreme ultraviolet lithography (EUVL) are based on a multi-layer structure known as distributed Bragg reflectors, comprising, in one aspect, alternating layers Mo and Si with the topmost layer consisting of about 40 Å of Si. When exposed to EUV, i.e., radiation in the range of 3-15 nm, that fraction of the EUV absorbed by the Si surface will generate photoelectrons. For a Mo/Si multilayer optic approximately 35% of the radiation at 13.4 nm is absorbed at near normal incidence and generates photoelectrons. Where x-rays are used as the radiation source, grazing angle mirrors are used to direct the x-radiation. For a Au-coated plane mirror utilized at glancing angles for reflecting x-radiation, typically 4-10% of the incident x-radiation is absorbed by the mirror and produces photoelectrons.

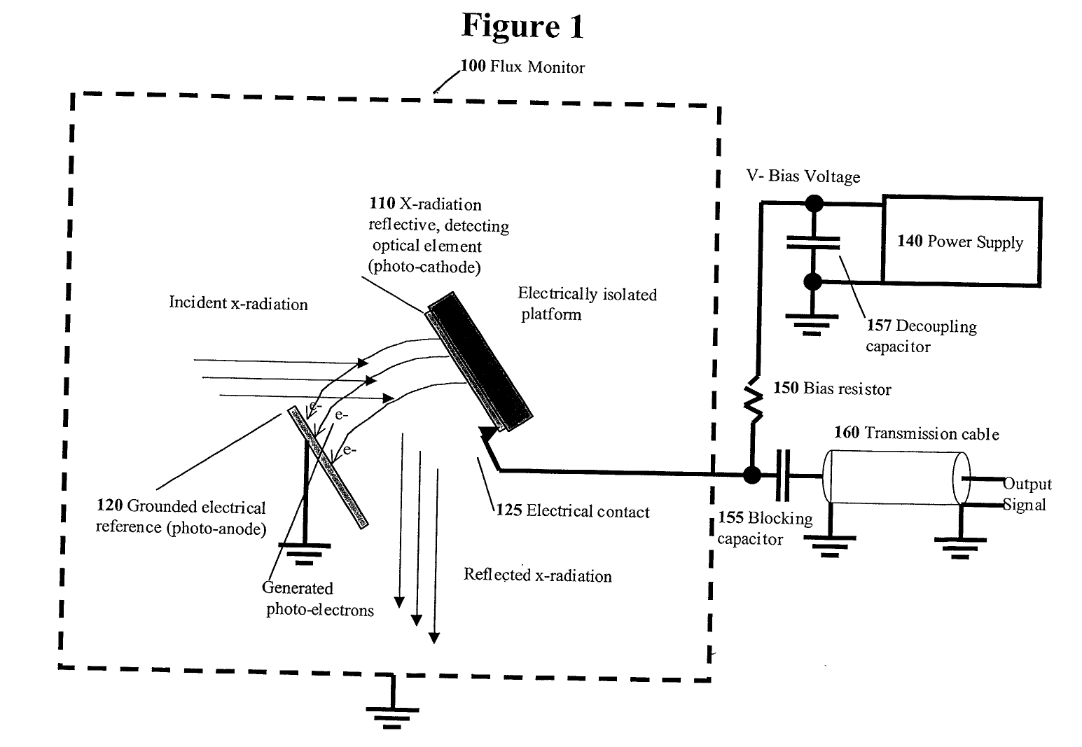

One embodiment of the present invention is show n in FIG. 1, which shows a flux monitor 100 that illustrates and exemplifies the invention. An electrical connection, which does not deform the optic figure, is made to an electrically isolated optic 110, which can be a multilayer mirror in the case of EUV radiation or a grazing incidence mirror for x-radiation, integrated into the optical system of a lithography tool. A bias voltage is applied to optic 110 from power supply means 140. The preferred value of this bias voltage is determined by systematic parameters but typically in the range of from about −10V to −150V. As discussed above, during operation of a radiation source that can be a pulsed EUV or x-ray source a pulse of photoelectrons is generated from the optic surface. This pulse of photoelectrons generates an electrical current between optic 110 and the electrically grounded photo-anode 120. The bias voltage applied to optic 110 is assumed to be sufficient to completely remove generated photoelectrons.

Resistor 150 is incorporated into the circuit to provide a constant current source and establish a measurable voltage signal. In order to eliminate extraneous DC signals and noise, various circuit elements, such as a DC blocking capacitor 155 and decoupling capacitor 157 can be incorporated into the circuit. It can be desirable to incorporate a coaxial cable 160 to provide a time delay to allow for the use of a laser-generated trigger signal in sampling the photoelectron current pulse. It w ill be appreciated by those skilled in the art, that various types of standard pulse-measuring and sampling circuitry can be used to measure the voltage signal from detector 100.

The radiation flux monitor described above can be used as part of a scheme to control precisely the radiation dose experienced by photoresist coated wafers. By way of example, a series of exposures of photoresist coated wafers are taken using varying radiation dose. As used herein, the term “dose” refers to a summation over time of a radiation flux. During each exposure the signal detected during each exposure by the flux monitor is summed to provide the total dose signal. Subsequently, each exposed photoresist coated wafer in the series of exposures is inspected to determine the correct dose of radiation required for proper exposure of that photoresist material. The total dose signal corresponding to the correct radiation dose is then utilized to provide a cutoff value for normal exposure operation. A running summation of the flux monitor signal is taken during exposure and once the proper dose has been reached the exposure can be halted.

In summary, the present invention provides a device for accurate monitoring of radiation flux by measuring the photoelectron current produced by the action of incident energetic radiation on a reflective metal surface.

The foregoing is intended to be illustrative of the present invention and is provided for purposes of clarity and understanding of the principles of this invention. Many other embodiments and modifications can be made by those of skill in the art without departing from the spirit and scope of the invention as defined in the following claims.

We claim:

1. A device for measuring a radiation flux from a surface, comprising:
a metal surface capable of emitting a flux of photoelectrons when illuminated by incident energetic radiation;
an electrically grounded photo-anode to receive the flux of emitted photoelectrons; and
an electrical circuit connected to said metal surface to convert the flux of emitted photoelectrons to an electrical signal.

2. The device of claim 1, wherein said metal surface comprises the Si surface of a multilayer Mo/Si optic.

3. The device of claim 1, wherein said metal surface comprises the Rh surface of a Ru grazing incidence mirror.

4. The device of claim 1, wherein the incident energetic radiation is radiation having a wavelength between about 3 and 15 nm.

5. A device for measuring a pulsed radiation flux from a surface, comprising:
a metal surface capable of emitting a flux of photoelectrons when illuminated by a beam of pulsed incident energetic radiation;
power supply means to produce a bias voltage sufficient to ensure substantially complete removal of the pulse of emitted photoelectrons from the surface;
an electrically grounded photo-anode to receive the flux of photoelectrons;
electrical connection between said metal surface and an electrical circuit to convert the flux of photoelectrons to an electrical signal;
means for establishing a measurable signal voltage; and
means to measure the signal voltage.

6. The device of claim 5, wherein said metal surface comprises the Si surface of a multilayer Mo/Si optic.

7. The device of claim 5, wherein the bias voltage is between about −10 and −150 V with respect to the photo-anode.

8. The device of claim 5, further including a coaxial cable between the electrical circuit and said current measuring means to provide a time delay.

9. The device of claim 5, w herein the incident energetic radiation is radiation having a wavelength in the range of from about 3 to about 15 nm.

10. A method for measuring a radiation flux from a surface, comprising:
providing a metal surface capable of emitting a flux of photoelectrons when illuminated by a beam of incident radiation;
providing a grounded photo-anode to receive the flux of photoelectrons;
connecting the metal surface to an electrical circuit capable of converting the emitted photoelectrons to an electrical current;
converting the electric current to a measurable signal voltage; and
measuring the signal voltage produced to determine the flux of radiation emitted by the metal surface.
